(19) United States
(12) Patent Application Publication
(10) Pub. No.: US 2005/0219761 A1
(43) Pub. Date: Oct. 6, 2005

(54) Disk device

(75) Inventor: Toshiaki Abe, Nishitama-gun (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/087,700

(22) Filed: Mar. 24, 2005

(30) Foreign Application Priority Data
Mar. 31, 2004 (JP) 2004-107649

(51) Int. Cl. G11B 5/012

(52) U.S. Cl. 360/265

(57) ABSTRACT

A head actuator of a disk device has a support frame formed of metal. A voice coil of a voice coil motor has a winding central axis that extends substantially parallel to a rotation axis of the head actuator. An outer peripheral portion of the voice coil has opposite outer peripheral portions opposed to the support frame and an exposed outer peripheral portion situated on the outermost periphery with respect to the bearing portion. The voice coil is fixed to the support frame with a resin molded between the support frame and the opposite outer peripheral portions. A lead wire of the voice coil is covered by a molded resin and fixed in a predetermined position on the head actuator. Annular upper and lower surfaces and the exposed outer peripheral portion of the voice coil are exposed to the outside without being covered with the resin.

### CROSS-REFERENCE TO RELATED APPLICATIONS

This application is based upon and claims the benefit of priority from prior Japanese Patent Application No. 2004-107649, filed Mar. 31, 2004, the entire contents of which are incorporated herein by reference.

### BACKGROUND OF THE INVENTION

1. Field of the Invention

This invention relates to a disk device provided with disk-shaped recording media.

2. Description of the Related Art

In recent years, disk devices, such as magnetic disk devices, optical disk devices, etc., have been widely used as external recording devices of computers and image recording devices.

A magnetic disk device as an example of a disk device generally has a case in the form of an open-topped rectangular box and a top cover that closes a top opening of the case. The case contains magnetic disks for use as magnetic recording media, a spindle motor, magnetic heads, and a head actuator. The spindle motor serves as drive means that supports and rotates the disks. The magnetic heads are used to write and read information to and from the disks. The head actuator supports the magnetic heads for movement with respect to the magnetic disks. Further, the case contains a voice coil motor, a substrate unit, etc. The voice coil motor rocks and positions the head actuator. The substrate unit has a head IC and the like.

The voice coil motor has a voice coil, which is located at an end portion of the head actuator, and a magnet and a yoke that are fixed to the case and opposed to the voice coil. A rotational force is produced by interaction between the magnetic field of the magnet and a magnetic field that is generated when the voice coil is energized, whereby the head actuator is rotated.

A structure for fixing a voice coil to a head actuator is described in, for example, Jpn. Pat. Appln. KOKAI Publication No. 2-55558. In this structure, the voice coil is fixed with an adhesive to a metal frame that extends from the head actuator. According to Jpn. Pat. Appln. KOKAI Publication No. 2003-224955, there is provided a structure in which a whole voice coil is covered by a resin mold and formed integrally with an actuator.

In the former fixing structure that uses the adhesive, the bond strength of the voice coil is liable to variation that is attributable to variation in the shape of a bonded surface of the coil. In order to keep the bond strength of the voice coil, therefore, the fill, viscosity, etc. of the adhesive must be watched very carefully. In connecting coil terminals to terminals on the actuator side during assembly of the actuator, connecting wires for the voice coil must be formed. In this case, the adhesive must be also applied to the connecting wires for the purpose of suppressing the movement of the wires. Thus, the former fixing structure entails troublesome assembly work and cannot readily ensure a high manufacturing efficiency.

In the case of the latter fixing structure, on the other hand, management of the adhesive and forming of coil wires need not be performed because they are already completed by the time of mold forming. Structurally, however, the mold uniformly covers the whole outer periphery of the coil, so that the effective voice coil length is shorter than that for the former bonding structure by a margin equivalent to the thickness of the mold. Since that part which holds the voice coil is formed of a resin, moreover, the stiffness of a whole coil assembly is inevitably lower than that of the former structure that uses the metal frame. Modern high-capacity hard disk drives (hereinafter referred as HDDs) require an increasing servo frequency, so that the resonance frequency of the coil assembly must be increased. If the stiffness of the whole coil assembly is thus low, it is hard satisfactorily to increase the resonance frequency.

### BRIEF SUMMARY OF THE INVENTION

According to an embodiment of the present invention, there is provided a disk device comprising: a disk-shaped recording medium; a motor which supports and rotates the recording medium; a head which processes information for the recording medium; a head actuator which is rotatable around a bearing portion and supports the head for movement with respect to the recording medium; and a voice coil motor which rotates the head actuator around the bearing portion. The head actuator has a support frame extending from the bearing portion and formed of metal. The voice coil motor includes a voice coil, which has a winding central axis extending substantially parallel to a rotation axis of the head actuator and is located in the support frame, and a lead wire extending from the voice coil and having a connection end. The voice coil has an outer peripheral portion, and annular upper and lower surfaces, the outer peripheral portion including opposite outer peripheral portions opposed to the support frame and an exposed outer peripheral portion situated on the outermost periphery with respect to the bearing portion. The voice coil is fixed to the support frame with a resin molded between the support frame and the opposite outer peripheral portions, and the lead wire is covered by a molded resin and fixed in a predetermined position on the head actuator. The annular upper and lower surfaces and the exposed outer peripheral portion are exposed to the outside without being covered with the resin.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an HDD according to an embodiment of the invention;

FIG. 2 is an exploded perspective view of a head actuator in the HDD;

FIG. 3 is a perspective view of the head actuator;

FIG. 4 is a perspective view showing a support frame and a voice coil of the head actuator; and

FIG. 5 is a perspective view showing the reverse side of the support frame and the voice coil.

### DETAILED DESCRIPTION OF THE INVENTION

An embodiment in which this invention is applied to a HDD as a disk device will now be described in detail with reference to the accompanying drawings.

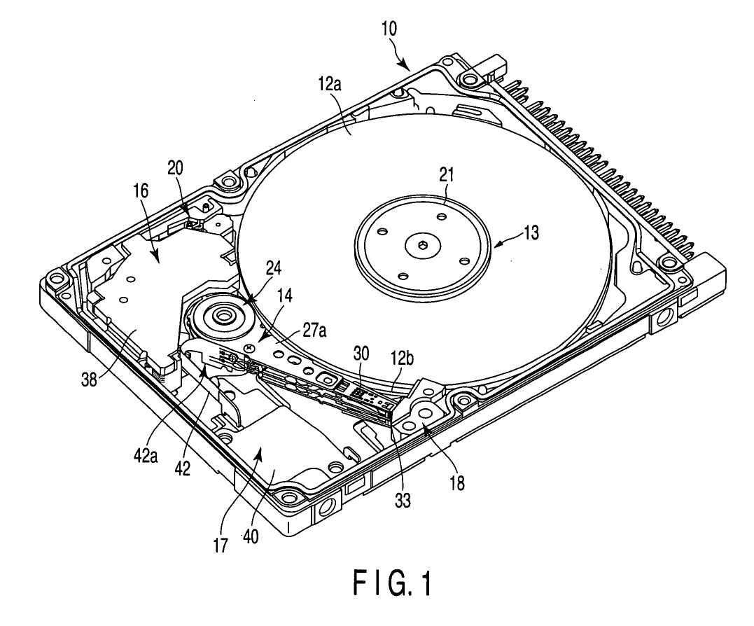

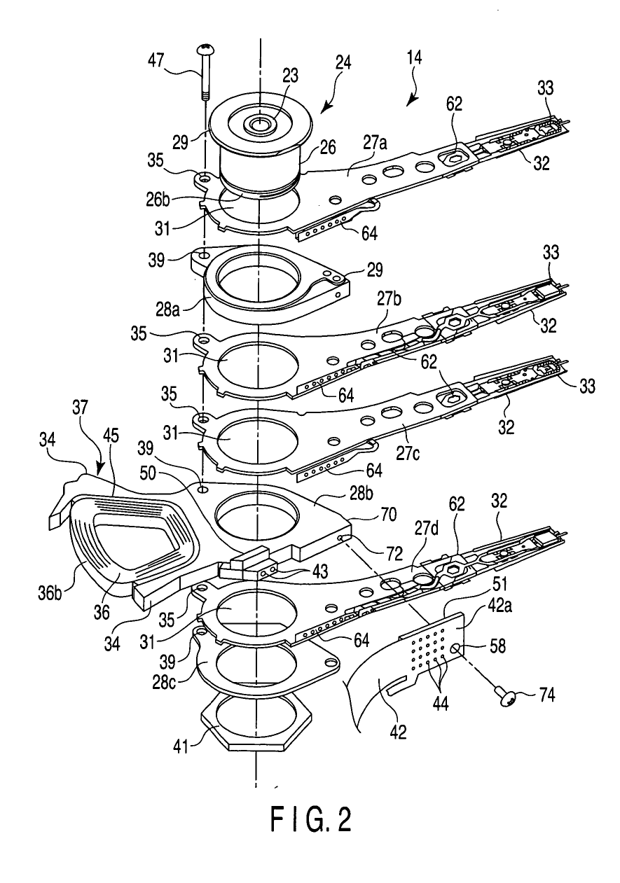

As shown in FIGS. 1 and 2, the HDD comprises a case 10 in the form of an open-topped rectangular box and a top cover (not shown), which is fixed to the case by screws and closes a top opening of the case.

The case 10 contains two magnetic disks 12a and 12b for use as recording media, spindle motor 13, magnetic heads, head actuator 14, voice coil motor (hereinafter referred as a VCM) 16, ramp load mechanism 18, inertia latch mechanism 20, and flexible printed circuit board unit (hereinafter referred as an FPC unit) 17. The magnetic heads record and reproduce information to and from the magnetic disks 12a and 12b. The head actuator 14 supports the magnetic heads for movement relative to the magnetic disks 12a and 12b. The VCM 16 rotates and positions the head actuator 14. The ramp load mechanism 18 holds the magnetic heads at distances from the magnetic disks 12a and 12b when the heads are moved to the outermost peripheries of the disks. The inertia latch mechanism 20 holds the head actuator 14 in a retreated position. Circuit components, such as a preamp, are mounted on the FPC unit 17.

A printed circuit board (not shown) that controls the operations of the spindle motor 13, VCM 16, and magnetic heads through the FPC unit 17 is screwed to the outer surface of the bottom wall of the case 10 and situated opposite the case bottom wall.

Each of the magnetic disks 12a and 12b is 65 mm (2.5 inches) in diameter, for example, and has magnetic recording layers on its upper and lower surfaces, individually. The two disks 12a and 12b are coaxially fitted on a hub (not shown) of the spindle motor 13 and clamped by a clamp screw 21. They are stacked in layers at a given space in the axial direction of the hub. The magnetic disks are rotated at a given speed by the motor 13 as a drive unit.

As shown in FIGS. 1 to 3, the head actuator 14 includes a bearing assembly 24 fixed on the bottom wall of the case 10. The bearing assembly 24, which serves as a bearing portion, has a pivot 23 set up on the bottom wall of the case 10 and a cylindrical hub 26 that is rotatably supported on the pivot by a pair of bearings. A ring-shaped flange 29 is formed on the upper end of the hub 26, and a screw portion 26b around the lower end portion.

The head actuator 14 is provided with four arms 27a, 27b, 27c and 27d mounted on the hub 26, four suspensions 32 extending individually from the arms, magnetic heads 33 supported individually on the respective extended ends of the suspensions, and three spacer rings 28a, 28b and 28c.

Each of the arms 27a to 27d is a thin flat plate of about 250 μm thickness formed of a stainless-steel-based material, such as SUS 304. A circular through hole 31 is formed in one end or proximal end of each arm. Each of the arms 27a to 27d has a lug that protrudes from its proximal end, and a positioning hole 35 is formed in the lug.

Each suspension 32 is formed of an elongate leaf spring with a thickness of 60 to 70 μm, and its proximal end is fixed to the distal end of its corresponding one of the arms 27a to 27d by spot welding or adhesive bonding and extends from the arm. The suspension 32 and its corresponding arm may be formed integrally of the same material.

Each magnetic head 33 has a substantially rectangular slider (not shown) and a recording and reproducing magnetic resistance (MR) head formed on the slider, and is fixed to a gimbals portion that is formed on the distal end of each suspension 32. Each head 33 has four electrodes (not shown).

As shown in FIG. 2, each magnetic head 33 of the head actuator 14 is connected electrically to a main FPC 42 (mentioned later) through a relay flexible printed circuit board (hereinafter referred as a relay FPC) 62. The relay FPC 62 is fixedly stuck on the respective surfaces of each arm and suspension of the test tube 1 and extends from the distal end of the suspension to the proximal end of the arm. The relay FPC 62 is in the form of an elongate belt as a whole. Its distal end is connected electrically to the magnetic head 33, while its proximal end portion extends outward from the proximal end of the arm and forms a terminal area 64 that has a plurality of connector pads.

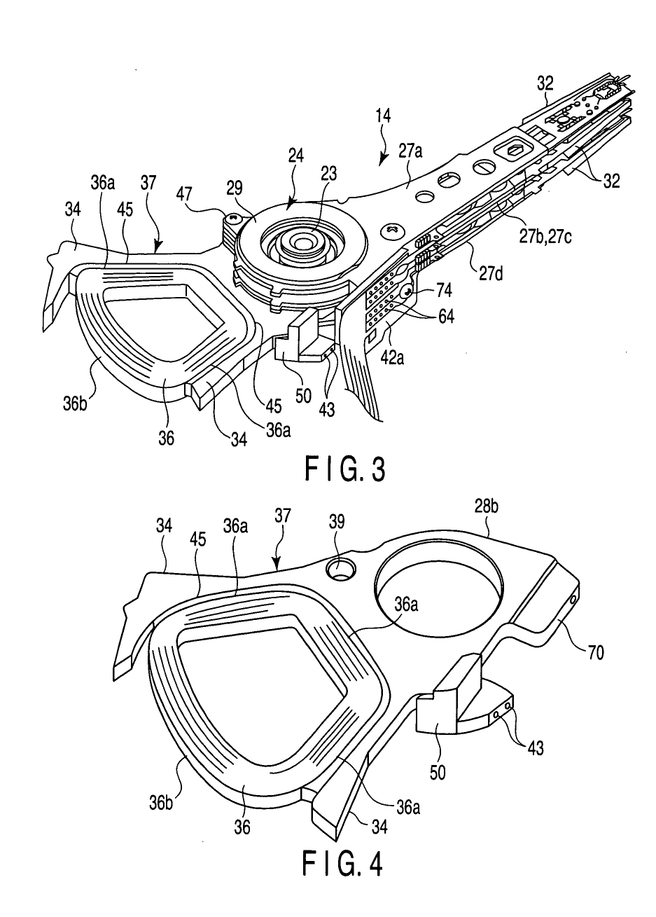

As shown in FIGS. 2 and 3, the four arms 27a to 27d are stacked in the axial direction of the hub 26 on the flange 29 when they are fitted on the hub in a manner such that the hub penetrates the through hole 31. The spacer rings 28a, 28b and 28c are sandwiched between the arms 27a and 27b, between the arms 27c and 27d, and between a nut 41 (mentioned later) and the arm 27d, respectively, as they are fitted on the hub 26. Each of the spacer rings 28a to 28c has a lug on the outside, and a screw mounting hole 39 for a fixing screw is formed in the lug.

The four arms 27a to 27d and the spacer rings 28a to 28c that are fitted on the hub 26 are interposed between the nut 41, which is threadedly fitted on the screw portion 26b of the hub 26, and the flange 29, and are fixedly held on the outer periphery of the hub 26. A positioning screw 47 is passed through the positioning holes 35 in the arms 27a to 27d and the screw mounting holes 39 in the spacer rings 28a to 28c from above, and is screwed in the screw mounting hole in the lowermost spacer ring 28c. Thus, the arms 27a to 27d and the spacer rings 28a to 28c are relatively positioned with respect to the circumferential direction of the hub 26. The four arms 27a to 27d extend in the same direction from the hub 26. These arms and the suspensions 32 can rock integrally with the hub 26.

The arms 27a and 27b are situated parallel to each other and spaced, and the suspensions 32 and the magnetic heads 33 on these arms are situated opposite one another. The arms 27c and 27d are situated parallel to each other and spaced, and the suspensions 32 and the magnetic heads 33 on these arms are situated opposite one another.

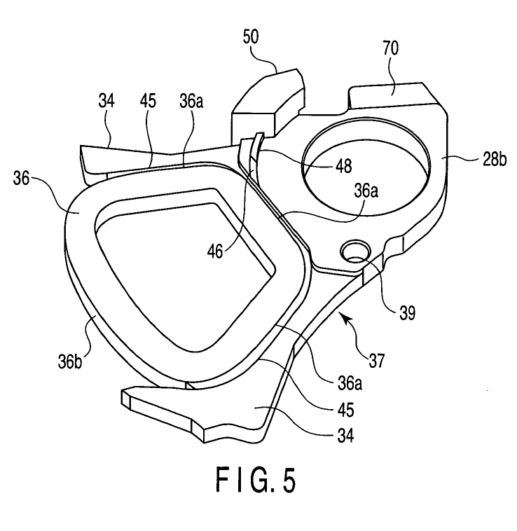

As shown in FIGS. 2 to 5, the spacer ring 28b has a pair of support arms 34 that extend in the direction opposite from the arms 27a to 27d with respect to the hub 26. It is formed integrally of metal, such as aluminum or stainless steel. The paired support arms 34 extend substantially radially from the pivot 23 and are spaced from each other. In conjunction with the spacer ring 28b, they constitute a substantially U-shaped support frame 37.

A voice coil 36 that constitutes a part of the VCM 16 is fixed to the support frame 37. The voice coil 36 has a winding axis that extends substantially parallel to the pivot 23 of the bearing assembly 24, and is wound in the shape of a substantially rectangular frame. The voice coil 36 is located between the support arms 34. The voice coil 36 has an outer peripheral portion, and annular upper and lower surfaces. The outer peripheral portion of the voice coil 36 includes three opposite-side outer peripheral portions 36a and one exposed outer peripheral portion 36b. The outer peripheral portions 36a are adjacently opposed to the support frame 37. The exposed outer peripheral portion 36b is situated on the outermost periphery with respect to the pivot 23 and exposed to the outside.

The voice coil 36 is fixed to the support frame with a resin 45 that is insert-molded in gaps between the support frame 37 and the outer peripheral portions 36a. However, the annular upper and lower surfaces, and the exposed outer peripheral portion 36b of the voice coil 36 are exposed to the outside without being covered by the resin. A lead wire 46 that extends from the voice coil 36 is pulled around on the surface of the spacer ring 28b and fixed to the spacer ring in a manner such that it is covered by a molded resin 48. A leading end or connection end of the lead wire 46 is embedded in a molded connector 50 on a side edge portion of the spacer ring 28b. The connection end of the wire 46 is connected to connection terminals 43 that are embedded in the connector 50.

The spacer ring 28b is provided integrally with a lug 70, which projects so as to be substantially flush with on side edge of each of the arms 27c and 27d. This lug 70 is formed having a tapped hole 72 for screwing a connection end portion 42a of the main FPC, which will be mentioned later.

With the head actuator 14 of the above-described construction incorporated in the case 10, as is well seen from FIG. 1, the magnetic disks 12a and 12b are situated between the arms 27a and 27b and between the arms 27c and 27d, respectively.

When the HDD is on, the magnetic heads 33 on the arms 27a and 27b face the upper and lower surfaces, respectively, of the magnetic disk 12a and hold the disk 12a from both sides. Likewise, the magnetic heads 33 on the arms 27c and 27d face the upper and lower surfaces, respectively, of the magnetic disk 12b and hold the disk 12b from both sides.

When the head actuator 14 is incorporated in the case 10, the voice coil 36 fixed to the support frame 37 is situated between a pair of yokes 38 that are fixed on the case 10. The voice coil 36, along with the yokes 38 and a magnet (not shown) fixed to one of the yokes, constitutes the VCM 16. When the voice coil 36 is energized, the head actuator 14 rotates, whereupon the magnetic heads 33 are moved to and positioned on desired tracks of the magnetic disks 12a and 12b.

As shown in FIG. 1, the FPC unit 17 has a base portion 40 and the main flexible printed circuit board (hereinafter referred as a main FPC) 42. The base portion 40 is formed by bending a flexible printed circuit board into a substantially rectangular shape. The main FPC 42 is in the form of an elongate belt that extends from the base portion. An extended end portion of the main FPC 42 constitutes the connection end portion 42a. As shown in FIG. 2, a large number of connector pads 44 are formed on one surface of the connection end portion 42a. Each connector pad 44 is connected electrically to the side of the base portion 40 by a conductor wire (not shown) of the main FPC 42. A reinforcing plate 51 in the form of a substantially rectangular plate is fixed to the other surface of the connection end portion 42a. The end portion 42a is screwed to the proximal end portion of the head actuator 14 in a manner such that a fixing screw 74 is screwed into the tapped hole 72 of the spacer ring 28b through a through hole 58.

As shown in FIGS. 2 and 3, the terminal areas 64 of the relay FPCs 62 that extend from the arms 27a to 27d are positioned on the connection end portion 42a of the main FPC 42. The connection pads of each terminal area 64 are soldered to their corresponding connector pads 44 on the side of the connection end portion 42a. Thus, the main FPC 42 is connected electrically and mechanically to the four relay FPCs 62. In other words, the head actuator 14 and the FPC unit 17 are connected electrically and mechanically to each other, thereby forming a head actuator unit.

According to the HDD constructed in this manner, the voice coil 36 is fixed to the support frame 37 with the molded resin 45. The lead wire 46 of the voice coil 36 is covered by the molded resin 48. It is molded in a given shape when it is fixed to the spacer ring 28b. Thus, fixing the voice coil 36 and forming the lead wire 46 can be carried out simultaneously by insert molding, so that the number of manufacturing processes can be reduced, and the head actuator can be manufactured efficiently.

Further, the support frame 37 that is formed of a high-stiffness material, such as metal, is used as a support portion for the voice coil 36 and fixed with the insert-molded resin. By doing this, the retention force of the voice coil can be enhanced to increase the resonance frequency. In this case, the exposed outer peripheral portion 36b of the voice coil 36 that is situated on the outermost periphery is exposed without being covered by the resin. If the size of the head actuator is fixed, therefore, the effective coil length can be maximized.

The coil terminals can be also arranged in necessary regions only, so that wires can be prevented from being carelessly cut in undesired positions, and the lead wire can be prevented from lifting.

More specifically, according to the present embodiment, the conductor portion of the lead wire is housed in the resin, and its exposed portion is joined to the FPC. Unlike the conventional exposed lead wire, therefore, the lead wire of the embodiment dispenses with forming or any other operation for manual disposition. Thus, snapping of the lead wire during such operation or its lifting at the time of mounting can be avoided.

The present invention is not limited directly to the embodiment described above, and its components may be embodied in modified forms without departing from the scope or spirit of the invention. Further, various inventions may be made by suitably combining a plurality of components described in connection with the foregoing embodiment. For example, some of the components according to the foregoing embodiment may be omitted. Furthermore, components according to different embodiments may be combined as required.

The number of magnetic disks in the HDD is not limited to two and may be increased or decreased as required. This invention is not limited to magnetic disk devices and may be also applied to any other disk devices, such as optical disk devices.

1. A disk device comprising:
a disk-shaped recording medium;
a motor which supports and rotates the recording medium;
a head which processes information for the recording medium;
a head actuator which is rotatable around a bearing portion and supports the head for movement with respect to the recording medium; and
a voice coil motor which rotates the head actuator around the bearing portion, the head actuator having a support frame extending from the bearing portion and formed of metal,
the voice coil motor including a voice coil, which has a winding central axis extending substantially parallel to a rotation axis of the head actuator and is located in the support frame, and a lead wire extending from the voice coil and having a connection end,
the voice coil having an outer peripheral portion, and annular upper and lower surfaces, the outer peripheral portion including opposite outer peripheral portions opposed to the support frame and an exposed outer peripheral portion situated on the outermost periphery with respect to the bearing portion,
the voice coil being fixed to the support frame with a resin molded between the support frame and the opposite outer peripheral portions, the lead wire being covered by a molded resin and fixed in a predetermined position on the head actuator, and the annular upper and lower surfaces and the exposed outer peripheral portion being exposed to the outside without being covered with the resin.

2. A disk device according to claim 1, wherein the head actuator includes a connector molded on the head actuator so as to overlap the connection end of the lead wire.

3. A disk device according to claim 1, wherein the support frame is substantially U-shaped and the voice coil is wound in a substantially rectangular shape and has three opposite-side outer peripheral portions individually opposed to the support frame and the one exposed outer peripheral portion.

4. A disk device according to claim 3, wherein the head actuator includes arms extending from the bearing portion and supporting the heads, and a spacer ring fitted on the bearing portion and interposed between the arms,
the support frame includes a pair of support arms extending from the spacer ring in a direction opposite to the arms, and the voice coil is arranged between the support arms.
